(19) United States
(12) Patent Application Publication
(10) Pub. No.: US 2012/0170145 A1
(43) Pub. Date: Jul. 5, 2012

(54) MIRROR ASSEMBLY FOR REDUCING BLIND SPOT ASSOCIATED WITH SIDE VIEW MIRRORS FOR VEHICLES

(76) Inventor: Jaehyong Kim, Fort Lee, NJ (US)

(21) Appl. No.: 13/334,189

(22) Filed: Dec. 22, 2011

Related U.S. Application Data
(63) Continuation-in-part of application No. 12/983,248, filed on Dec. 31, 2010, now abandoned.

(51) Int. Cl. B60R 1/08

(52) U.S. Cl. 359/872; 359/871

(57) ABSTRACT

A mirror assembly for reducing a blind spot associated with an exterior mounted side view mirror of a vehicle is provided. The mirror assembly includes a mount assembly configured for being received about an interior intersection of the A-pillar and the door panel of the vehicle. The mirror assembly also has a mirror carried by the mount assembly and positioned within a sightline defined when the operator is viewing the exterior mounted side view mirror.

### CROSS REFERENCE TO RELATED APPLICATIONS

This application is a continuation-in-part of U.S. application Ser. No. 12/983,248 filed on Dec. 31, 2010, the entire contents of which are hereby incorporated by reference herein.

### TECHNICAL FIELD

This disclosure is directed towards side view mirrors for vehicles. Specifically, this disclosure is directed to mirrors for determining the presence of vehicles and other objects positioned in the blind spot of an exterior mounted side view mirror of an automotive vehicle.

### BACKGROUND

For many years vehicles have used mirrors affixed to the exterior of the body of a vehicle or to the windscreen adjacent to the driver position, known as the A-pillar, for side viewing.

Various types of mirrors have been proposed as an improvement to conventional side view mirrors for use with automotive vehicles. These include a mirror having a single flat or convex surface that is located forward of the driver to direct a reflected image of objects located behind the vehicle into the line of sight of the vehicle operator. Because a centrally located mirror does not provide adequate side visibility, many vehicles use one or more side view mirrors mounted on the exterior surface of vehicle doors to reflect images to the side and rear of the vehicle to the vehicle operator. These side view mirrors provide a limited field of vision. Even using the combined application of a central rear view mirror and one or more outwardly extending side rear view mirrors, a driver still may have significant blind spots large enough to restrict viewing of other vehicles or objects in close proximity. Accidents occur because of the limited viewing capacity afforded by such mirrors.

Previously proposed mirrors tend to have configurations that are awkward, unstylish or non-aerodynamic. Further, mirrors that seek to reduce the blind spot by increasing the mirror size take up excessive room on the exterior of the vehicle while obscuring the view of the driver when looking forward, creating an additional hazard.

Thus, there has not been an effective device or apparatus for eliminating blind spots in the side view scope of vision of an automotive vehicle. Accordingly, it is desirable to provide a mirror and/or mirror system that reduces or eliminates one or more blind spots for a driver of a suitable automotive vehicle while addressing the limitations of conventional devices.

### SUMMARY

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter.

Disclosed herein is a mirror assembly for reducing a blind spot associated with an exterior mounted side view mirror of a vehicle. The mirror assembly includes a mount assembly configured for being received about an interior intersection of the A-pillar and the door panel of the vehicle.

According to one or more embodiments, the mount assembly may include an interior mount that defines a spatial footprint generally corresponding to a spatial footprint of a mount of the exterior mounted side view mirror.

According to one or more embodiments, the mirror assembly has a mirror carried by the mount assembly and positioned within a sightline defined when the operator is viewing the exterior mounted side view mirror.

According to one or more embodiments, the mount assembly may have a support member extending from the mount to the mirror.

According to one or more embodiments, the mount assembly may have a support member extending from the mount to the rear surface of the mirror.

According to one or more embodiments, the mirror may be positioned so that the mirror covers a portion of the mount assembly.

According to one or more embodiments, the mirror is aligned generally with a proximal edge surface of the mount assembly.

According to one or more embodiments, a mirror assembly that includes a mount assembly as described above and a housing integrally formed therewith is provided.

According to one or more embodiments, the housing assembly is positioned within the sightline defined when the vehicle operator is viewing the exterior mounted side view mirror.

According to one or more embodiments, the mount assembly may be configured as a replacement for the interior trim insert of a vehicle.

According to one or more embodiments, a mirror assembly with a mount assembly that has an interior mount defining a spatial footprint generally corresponding to a spatial footprint of a mount of the exterior mounted side view mirror is provided. The interior mount may be configured for being received about an interior intersection of the A-pillar and the door panel of the vehicle.

### BRIEF DESCRIPTION OF THE DRAWINGS

The foregoing Summary, as well as the following Detailed Description of preferred embodiments, is better understood when read in conjunction with the appended drawings. For the purposes of illustration, there is shown in the drawings exemplary embodiments; however, the presently disclosed invention is not limited to the specific methods and instrumentalities disclosed. In the drawings:

FIG. 1 illustrates a perspective view of a mirror assembly according to one or more embodiments disclosed herein;

FIG. 2 illustrates a perspective view of a mirror assembly in a vehicle according to one or more embodiments disclosed herein;

FIG. 3 illustrates a perspective view of an exterior of a vehicle;

FIG. 4 illustrates a perspective view of a mirror assembly carried by the A-pillar of a vehicle according to one or more embodiments disclosed herein;

FIG. 5A illustrates a perspective view of a mirror assembly according to one or more embodiments disclosed herein;

FIG. 5B illustrates a perspective view of a mirror assembly according to one or more embodiments disclosed herein;

FIG. 6A illustrates a perspective view of a mirror assembly according to one or more embodiments disclosed herein;

FIG. 6B illustrates a perspective view of a mirror assembly according to one or more embodiments disclosed herein;

FIG. 7A illustrates a perspective view of a mirror assembly according to one or more embodiments disclosed herein;

FIG. 7B illustrates a perspective view of a mirror assembly according to one or more embodiments disclosed herein;

FIG. 8 illustrates a top view of a vehicle having an exterior side view mirror with a reduced viewing area associated therewith shown with a broken line;

FIG. 9 illustrates a top view of a vehicle having a mirror assembly according to one or more embodiments disclosed herein with the expanded viewing area associated therewith shown with a dotted line;

FIG. 10 illustrates a perspective view of a mirror assembly in a vehicle according to one or more embodiments disclosed herein; and

FIG. 11 illustrates a perspective view of a mirror assembly in a vehicle according to one or more embodiments disclosed herein.

### DETAILED DESCRIPTION

This disclosure is described with specificity to meet statutory requirements. However, the description itself is not intended to limit the scope of this patent. Rather, the inventors have contemplated that the claimed inventions might also be embodied in other ways, to include different steps or elements similar to the ones described in this document, in conjunction with other present or future technologies.

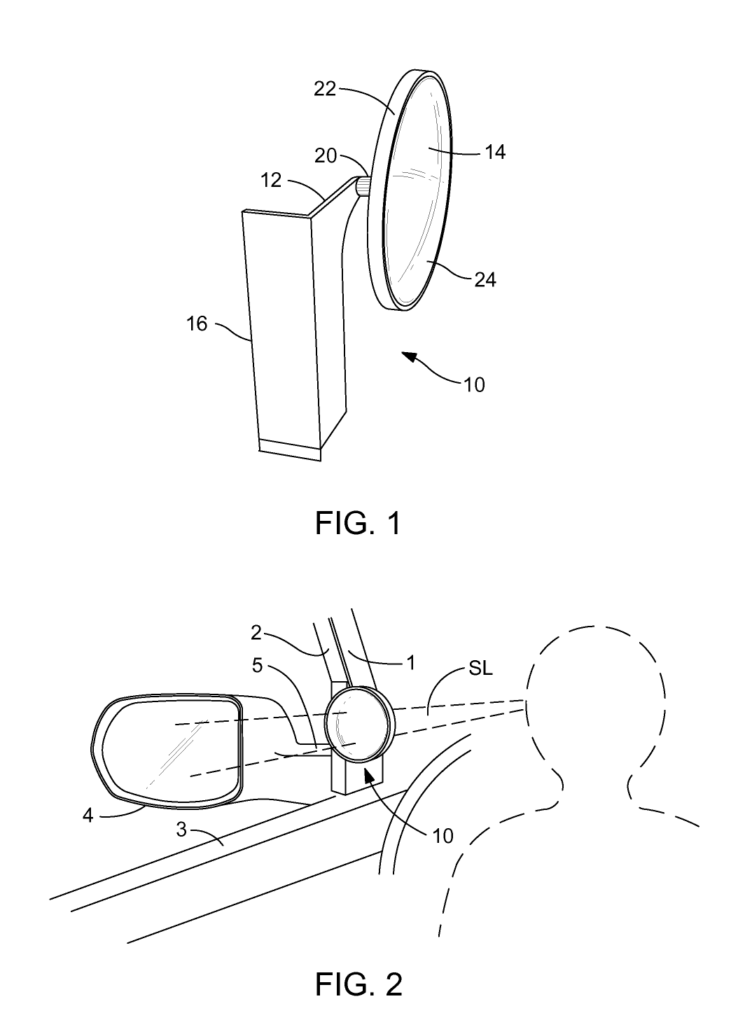

As illustrated throughout the drawings, and in particular with reference to FIGS. 1 and 2, a mirror assembly is provided and designated 10 throughout the drawings. The mirror assembly 10 is provided for reducing a blind spot associated with an exterior mounted side view mirror 4 of a vehicle. The mirror assembly 10 includes a mount assembly 12 configured for being received about an interior intersection of the A-pillar 2 and the door panel 3 of the vehicle. The “A-pillar” is a term of art used to define the support frame that is adjacent to the upwardly extending door frame of a vehicle chassis.

The mirror assembly 10 includes a mirror 14 carried by the mount assembly 12 and positioned within a sightline defined when the operator is viewing the exterior mounted side view mirror 4. The sightline is designated with a broken line and characters “SL” in FIG. 2.

The mount assembly 12 may include an interior mount 16. The interior mount 16 may define a spatial footprint generally corresponding to a spatial footprint of a mount 5 of the exterior mounted side view mirror 4. Spatial footprint is used to describe the area occupied by a respective element. In one more embodiments, the disclosed mirror assembly 10 obstructs less of an operator's field of vision than other devices since the spatial footprint of mount 5 generally corresponds to spatial footprint of mirror 4, thus obstructing no more of the operator's side view than already obstructed by the mirror 4.

By positioning the disclosed mirror assembly 10 within the sightline of the exterior mounted side view mirror 4, the vehicle operator may view both the exterior mounted side view mirror 4 and the interior mounted mirror assembly 10 simultaneously. Additionally, the mount assembly 12 may include a support member 20 extending from the mount 16 to the mirror 14. In one or more embodiments, the support member 20 may extend from the mount 16 to a rear surface 22 of the mirror 14 as illustrated in FIG. 1. In one or more embodiments, the mirror 14 may obscure a portion of the mount assembly 12 within the sightline of the operator or the mirror 14. In one or more embodiments, the mirror 14 may define a reflective surface 24 for presenting a reflected image of any vehicle or object located in the blind spot of the vehicle.

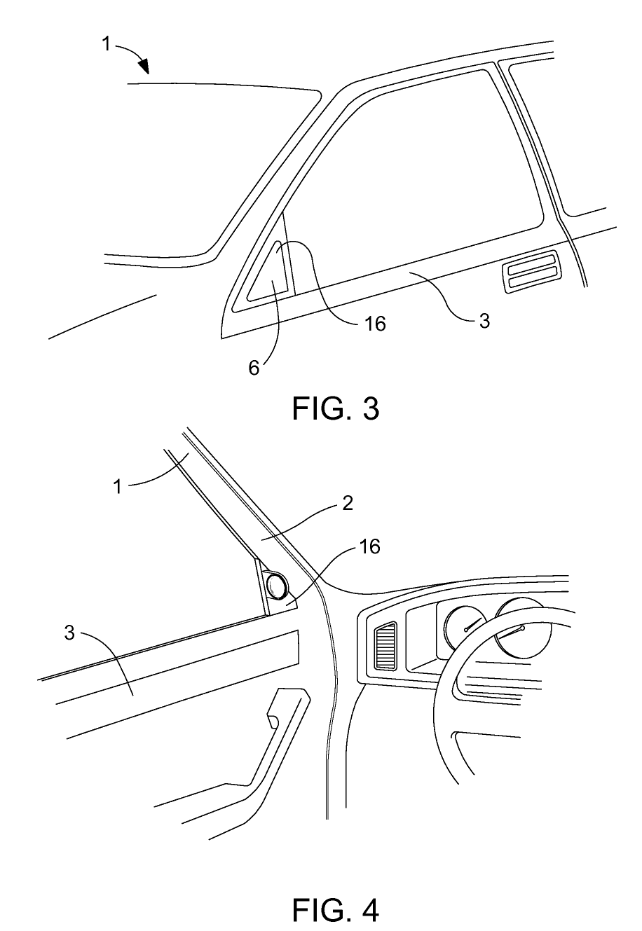

FIG. 3 illustrates a perspective view of the exterior of a vehicle 1 in which the spatial footprint of the interior mount 16 corresponds to the spatial footprint of the mount 5 of the exterior mounted side view mirror 4. This view shows that there may be complete overlap between the interior mount 16 and the exterior mount 5, which offers the vehicle operator a less obstructed view around the anterior and flanking portions of the vehicle 1 compared with conventional side view mirrors.

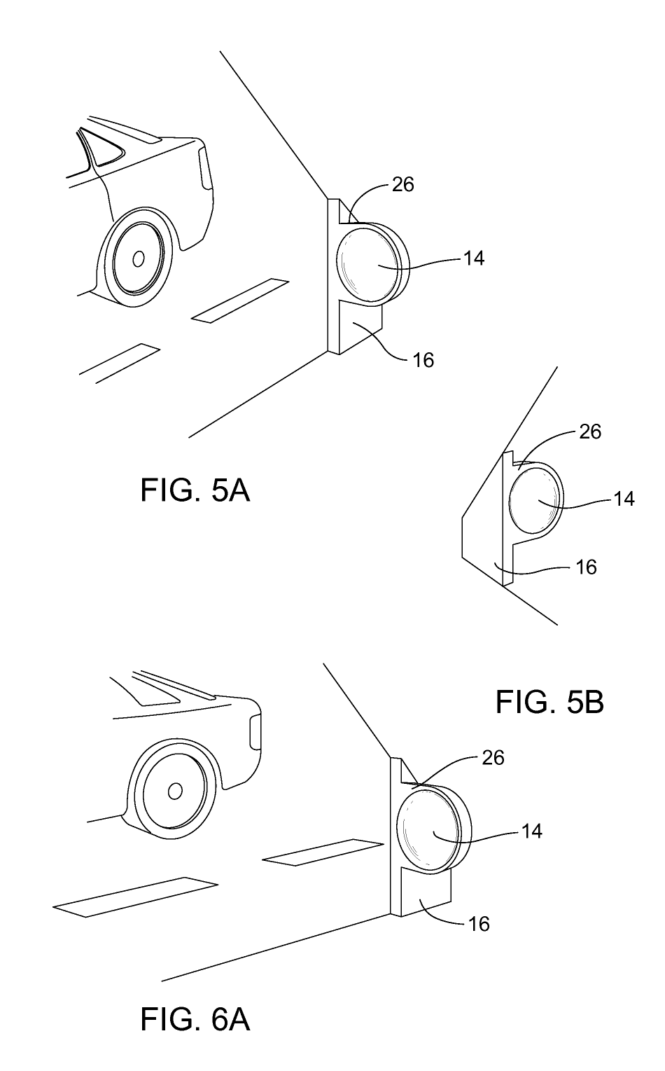

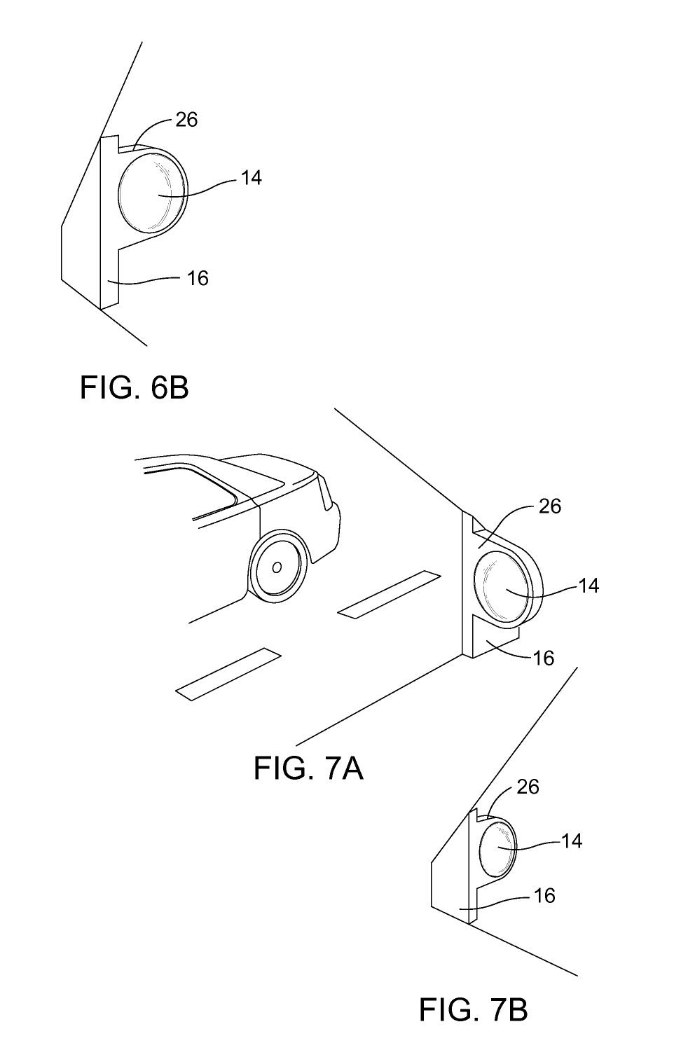

FIG. 4 illustrates a perspective view of one or more embodiments of mirror assembly 10 disclosed herein viewed from the interior of a vehicle. As illustrated more closely in FIGS. 5A through 7B, in one or more embodiments, the mirror 14 is carried by a housing 26 integrally formed with the mount assembly 12. By carrying the mirror 14 with a housing 26 integrally formed with a mount assembly 12, the mirror assembly 10 has fewer components to block the vision of a vehicle operator while simultaneously providing for additional structural stability and ease of manufacturing. In one or more embodiments, the reflective surface 24 may be generally aligned with a proximal edge surface of the mount assembly 12. Although the reflective surface 24 provided herein is generally aligned with the mount assembly, the mirror 14 is not limited to a fixed position. For example, the mirror 14 may be carried by the housing 26 by a flexible, pivoted, or articulated member that permits the mirror 14 to be adjustable to a range of vehicles.

FIGS. 5A through 7B illustrate one or more embodiments of the mirror assembly 10. FIGS. 5A, 6A, and 7A show a perspective view of the mirror assembly 10 viewed from the interior of a vehicle while FIGS. 5B, 6B, and 7B show a perspective view of the mirror assembly 10 viewed from the exterior of the vehicle. The mirror assembly 10 includes many similar features to mirror assemblies shown throughout the drawings in which all other like referenced elements are represented by like referenced numbers.

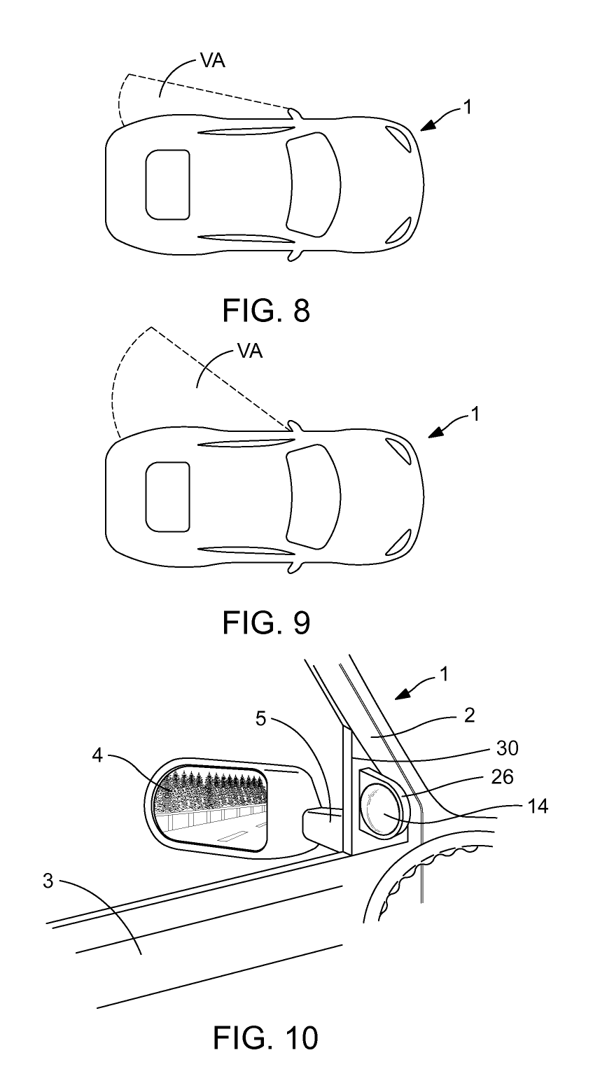

FIG. 8 illustrates a top view of a vehicle 1 having a conventional exterior mounted side view mirror 4, with a viewing area “VA” available to the vehicle operator defined as the area between the broken line and the side of the vehicle 1.

Alternatively, FIG. 9 illustrates a top view of a vehicle 1 having a conventional exterior mounted side view mirror 4 and one or more embodiments of an internally mounted mirror assembly 10 disclosed herein, with the viewing area “VA” available to the vehicle operator defined as the area between the broken line and the side of the vehicle 1. The viewing area available to the vehicle operator is appreciably larger when the vehicle 1 has the mirror assembly 10 disclosed herein.

FIG. 10 illustrates a perspective view of one or more embodiments of the mirror assembly 10 disclosed herein as viewed from the interior of a vehicle. In these one or more illustrated embodiments, the mount assembly 12 has been substituted with an insert 30 that is designed to replace a trim insert of the vehicle 1. By using the insert 30 instead of the mount assembly 12, the mirror assembly appears more aesthetically pleasing. Additionally, the use of the insert 30 may add further structural stability to the entire mirror assembly 10.

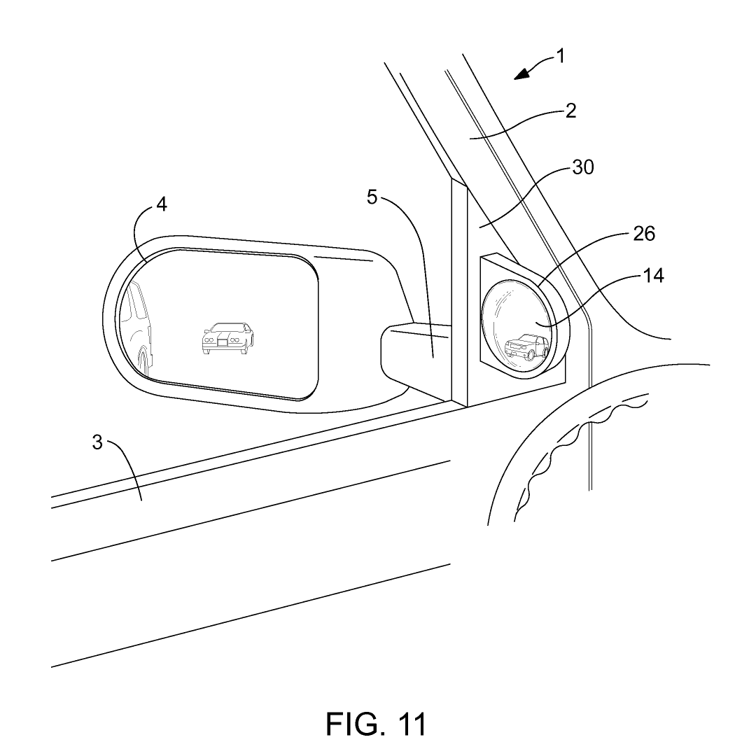

FIG. 11 illustrates a perspective view of the mirror assembly 10 disclosed herein from the interior of the vehicle. Specifically, the mirror assembly 10 disclosed herein allows the vehicle operator to view a vehicle that is almost entirely into the blind spot of the vehicle and therefore undetectable using the exterior mounted side view mirror 4.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A mirror assembly for reducing a blind spot associated with an exterior mounted side view mirror of a vehicle, the mirror assembly comprising:
a mount assembly configured for being received about an interior intersection of the A-pillar and the door panel of the vehicle; and
a mirror carried by the mount assembly and positioned within a sightline defined when the operator is viewing the exterior mounted side view mirror.

2. A mirror assembly of claim 1, wherein the mount assembly includes an interior mount defining a spatial footprint generally corresponding to a spatial footprint of a mount of the exterior mounted side view mirror.

3. A mirror assembly of claim 1, wherein the mount assembly further comprises a support member extending from the mount to the mirror.

4. A mirror assembly of claim 1, wherein the mount assembly further comprises a support member extending from the mount to a rear surface of the mirror.

5. A mirror assembly of claim 1, wherein the mirror is oriented such that the mirror obscures a portion of the mount assembly within the sightline defined when the operator is viewing the exterior mounted side view mirror.

6. A mirror assembly of claim 1, wherein the mirror defines a front reflective surface that is generally aligned with a proximal edge surface of the mount assembly.

7. A mirror assembly of claim 1, wherein the mirror is adjustable relative to the mount assembly.

8. A mirror assembly for reducing a blind spot associated with an exterior mounted side view mirror of a vehicle, the mirror assembly comprising:
a mount assembly configured for being received about an interior intersection of the A-pillar and the door panel of the vehicle; and
a housing integrally formed therewith, including a mirror positioned within a sightline defined when the operator is viewing the exterior mounted side view mirror.

9. A mirror assembly of claim 8, wherein the mount assembly is further configured for replacing the interior trim insert of a vehicle.

10. A mirror assembly of claim 8, wherein the mount assembly includes an interior mount defining a spatial footprint generally corresponding to a spatial footprint of a mount of the exterior mounted side view mirror.

11. A mirror assembly of claim 8, wherein the mirror is oriented such that the mirror obscures a portion of the mount assembly within the sightline.

12. A mirror assembly of claim 8, wherein the mirror defines a front reflective surface that is generally aligned with a proximal edge surface of the mount assembly.

13. A mirror assembly of claim 8, wherein the mirror is adjustable relative to the mount assembly.

14. A mirror assembly for reducing a blind spot associated with an exterior mounted side view mirror of a vehicle, the mirror assembly comprising:
a mount assembly including an interior mount defining a spatial footprint generally corresponding to a spatial footprint of a mount of the exterior mounted side view mirror and configured for being received about an interior intersection of the A-pillar and the door panel of the vehicle; and
a mirror carried by the mount assembly and that defines a front reflective surface that is generally aligned with a proximal edge surface of the mount assembly and positioned within a sightline defined when the operator is viewing the exterior mounted side view mirror.

15. A mirror assembly of claim 14, wherein the mount assembly further comprises a support member extending from the mount to the mirror.

16. A mirror assembly of claim 14, wherein the mount assembly further comprises a support member extending from the mount to a rear surface of the mirror.

17. A mirror assembly of claim 14, wherein the mirror is oriented such that the mirror obscures a portion of the mount assembly within the sightline.

18. A mirror assembly of claim 14, wherein the mirror is adjustable relative to the mount assembly.
